(19) United States
(12) Patent Application Publication
(10) Pub. No.: US 2007/0255888 A1
(43) Pub. Date: Nov. 1, 2007

(54) Method and apparatus for managing input data buffer of MP3 decoder

(75) Inventors: Sheng-Feng Ho, Taipei City (TW); Jui-Ting Hsieh, Jhongli City (TW); Wei-Min Chao, Jhongli City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/653,048

(22) Filed: Jan. 12, 2007

(30) Foreign Application Priority Data
Apr. 26, 2006 (TW) 095114804

(51) Int. Cl. G06F 12/00

(52) U.S. Cl. 711/100; 700/94

(57) ABSTRACT

A method for managing a memory is provided. The memory includes M memory units and is used for temporarily storing at least one audio frame in an audio bit stream. The audio bit stream includes N audio frames. The ith audio frame in the audio bit stream includes an ith main data with a size equal to Sᵢ memory units. The last used memory unit for storing the main data of the (i−1)th audio frame is the (L₍ᵢ₋₁₎)th memory unit in the memory. The method first receives the ith main data of the ith audio frame and judges whether the value of the Sᵢ is larger than an ith reference value. The method then selects a first part of the M memory units for storing the ith main data of the ith audio frame according to the judging result and the values of M, Sᵢ, and L₍ᵢ₋₁₎.

### BACKGROUND OF THE INVENTION

1. Field of the Invention

The present invention relates to an apparatus and a method for controlling a data buffer, and in particular to the apparatus and method for managing an input data buffer of an MP3 decoder.

2. Description of the Prior Art

MPEG Layer III (MP3) specification is a broadly used audio standard in current days. Please refer to FIG. 1, which illustrates the contents of a standard MP3 audio frame 10. A header 12 includes the basic information of the audio frame 10, for instances, type of MPEG, error correction codes, sampling frequency, and bit rates. In the side information block 14, reference information for decoding the audio frame 10, for example, information about re-quantization and Huffman decoding, is recorded. In the main data block 16, audio data is stored. Besides, in the ancillary data block 18, users can record information relative to the audio frame 10, for example, singers and the title of a song.

Although the size of the audio frame 10 and the size of main data block 16 are both fixed, the length of the audio data corresponding to the audio frame 10 is unfixed. Some audio data has lengths longer than the maximum limitation of the main data block 16, and some audio data has lengths shorter than that limitation. To improve the whole storage efficiency, when generating audio frames 10, users can adopt a bit-reservoir mechanism. Thus, the audio data corresponding to an audio frame 10 can be selectively stored in the main data blocks 16 of other audio frames 10.

After the bit-reservoir mechanism is adopted, the audio data corresponding to a certain audio frame 10 is not certainly stored in the main data blocks 16 of that audio frame 10. Therefore, the side information block 14 must further include a beginning index (typically labeled as main_data_begin) to indicate the real beginning position of the audio data corresponding to the audio frame 10.

Please refer to FIG. 2, which illustrates an example of audio frames with the bit-reservoir mechanism. Four audio frames are shown in this example: the first audio frame 21, the second audio frame 22, the third audio frame 23, and the fourth audio frame 24. Every audio frame respectively includes two blocks. Block A includes a header and side information; block B is a main data block (ancillary data blocks are not shown in this figure). As shown in FIG. 2, the size of the audio data corresponding to the first audio frame 21 is smaller than the capacity of the main data block 21B. Therefore, one part of the main data block 21B is used for storing the audio data corresponding to the first audio frame 22. Similarly, the main data block 22B of the second audio frame 22 stores both the audio data corresponding to the third audio frame 23 and one part of the audio data corresponding to the fourth audio frame 24.

Please refer to FIG. 3, which illustrates a block diagram of an MP3 decoder 30. The MP3 decoder 30 includes an audio frame analyzer 31, a side information buffer 32, a main data buffer 33, and an audio frame decoder 34. After the MP3 decoder 30 receives an audio frame, the audio frame analyzer 31 is responsible for finding out the beginning of the audio frame, calculating the length of the audio frame, and transmitting the side information and main data of the audio frame to the side information buffer 32 and main data buffer 33, respectively. Subsequently, the audio frame decoder 34 decodes the audio frame based on the information stored in the side information buffer 32 and main data buffer 33.

With the bit-reservoir mechanism, the audio data corresponding to the audio frame being decoded might be totally or partially stored in previous audio frames. Under this condition, most MP3 decoders in prior art turns back to access the previous audio frame. However, this abnormal access method wastes much processing time. To reduce the frequency of turning back, some MP3 decoders in prior art substantially increase the capacity of the main data buffer 33 for storing plural or all audio frames at a time. The disadvantage of this solution is that a large number of storage spaces are consumed.

### SUMMARY OF THE INVENTION

To solve the aforementioned problems, this invention provides methods and apparatuses for managing the main data buffer in an audio decoder. The audio decoder is used for decoding an audio bit stream that includes N audio frames. The main data buffer is a memory that includes M memory units and is used for temporarily storing at least one audio frame in the audio bit stream. The ith audio frame among the N audio frames includes an ith main data block with a size equal to Sᵢ memory units. N and M are both positive integers. Sᵢ is a positive integer smaller than or equal to M; i is an integer index ranging from 1 to N. In the examples below, it is assumed that the last used memory unit for storing the (i−1)th main data block is the (L₍ᵢ₋₁₎)th memory unit in the memory.

One preferred embodiment, according to this invention, is a method for managing the memory. In this method, the ith main data block in the ith audio frame is first received. Next, it is judged that whether the value of Sᵢ is larger than an ith reference value. Based upon the judging result and the values of M, Sᵢ, and L₍ᵢ₋₁₎, an ith set of memory units is selected from the M memory units. Then, the ith main data block is stored into the ith set of memory units.

The other preferred embodiment, according to this invention, is an apparatus for managing the memory. The apparatus includes a receiving module, a judging module, a selecting module, and a storing module. The receiving module is used for receiving the ith main data block in the ith audio frame. The judging module is coupled to the receiving module and used for judging whether the value of Sᵢ is larger than an ith reference value. According to judging result of the judging module and the values of M, Sᵢ, and L₍ᵢ₋₁₎, the selecting module selects an ith set of memory units from the M memory units. Then, the storing module stores the ith main data block into the ith set of memory units.

The advantage and spirit of the invention may be understood by the following recitations together with the appended drawings.

### BRIEF DESCRIPTION OF THE APPENDED DRAWINGS

FIG. 1 illustrates the contents of a standard MP3 audio frame.

FIG. 2 illustrates an example of audio frames with the bit-reservoir mechanism.

FIG. 3 illustrates a block diagram of an MP3 decoder in prior art.

FIG. 4 shows an example of storing the main data blocks of audio frames in the memory according to this invention.

FIG. 5 shows the flowchart of the managing method in the first preferred embodiment according to this invention.

FIG. 6 shows the block diagram when the managing apparatus, according to this invention, is integrated with an MP3 decoder.

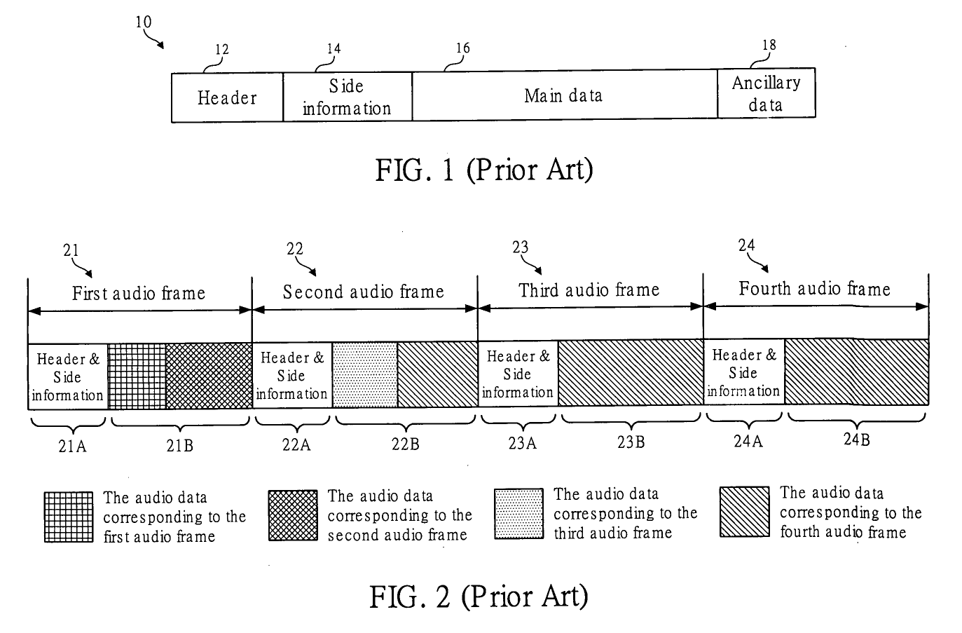

### DETAILED DESCRIPTION OF THE INVENTION

One main objective of this invention is to provide methods and apparatuses for managing the main data buffer in an MP3 decoder. According to this invention, the concept of circular input buffers (CIB) is used for managing the main data buffer in an MP3 decoder.

In the examples below, it is assumed that the MP3 decoder is used for decoding an audio bit stream including N audio frames. The main data buffer is a memory including M memory units and is used for temporarily storing at least one audio frame in the audio bit stream. The ith audio frame among the N audio frames includes an ith main data block with a size equal to Sᵢ memory units. N and M are both positive integers. Sᵢ is a positive integer smaller than or equal to M; i is an integer index ranging from 1 to N. Besides, it is assumed that the last used memory unit for storing the (i−1)th main data block is the (L₍ᵢ₋₁₎)th memory unit in the memory.

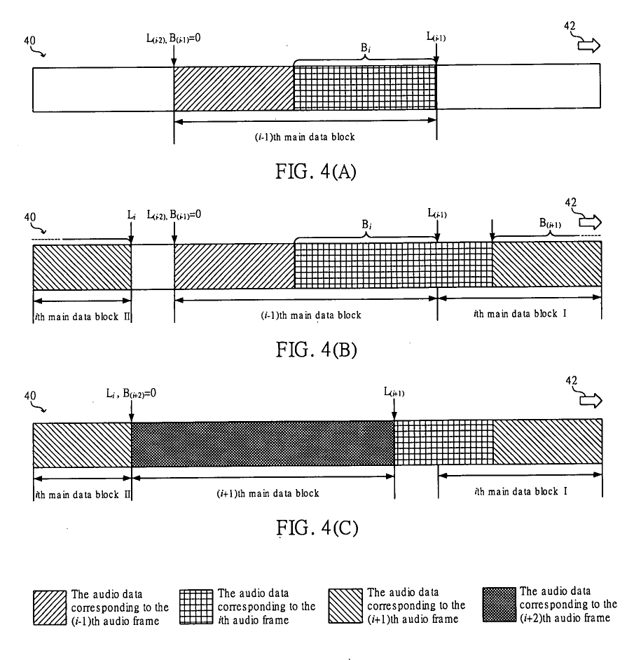

FIG. 4 shows an example of storing the main data blocks of audio frames in the memory according to this invention. In a memory 40, data is sequentially stored into the memory units in the direction along the arrow 42. As shown in FIG. 4(A), before the ith main data block is stored into the memory 40, the (i−1)th main data block of the (i−1)th audio frame has been stored in the (L₍ᵢ₋₂₎+1)th through the L₍ᵢ₋₁₎th memory units in the memory 40. As described above, with the bit-reservoir mechanism, the ith audio frame is corresponding to an ith audio data. However, the ith audio data is not certainly and totally stored in the ith main data block of the ith audio frame. Hence, besides the (i−1)th audio data corresponding to the (i−1)th audio frame, the (i−1)th main data block also includes one part of the ith audio data corresponding to the ith audio frame.

The (i−1)th beginning index (B₍ᵢ₋₁₎) in FIG. 4(A) represents a relative relation between the (i−1)th audio data and the (i−1)th main data block. In this example, B₍ᵢ₋₁₎ is zero. In other words, the beginning position of the (i−1)th audio data is the same as that of the (i−1)th main data block.

When an MP3 decoder starts to store the ith main data block of the ith audio frame into the memory 40, the methods and apparatuses, according to this invention, first judges whether the value of Sᵢ (i.e. the size of the ith main data block) is larger than an ith reference value. The ith reference value can be the difference between the values of M and L₍ᵢ₋₁₎. In other words, the ith reference value can be equal to the distance from the end position of the (i−1)th main data block to the end of the memory 40. If Sᵢ is smaller than the ith reference value, it means the memory units located between the end position of the (i−1)th main data block and the end of the memory 40 are enough for storing the ith main data block. Under this condition, the methods and apparatuses, according to this invention, store the ith main data block after the (i−1)th main data block. That is to say, the ith main data block is stored in the (L₍ᵢ₋₁₎+1)th through the (L₍ᵢ₋₁₎+Sᵢ)th memory units of the memory 40.

FIG. 4(B) illustrates the condition when Sᵢ is larger than the ith reference value. If Sᵢ is larger than the ith reference value, it means the memory units located between the end position of the (i−1)th main data block and the end of the memory 40 are not enough for storing the ith main data block. Under this condition, the methods and apparatuses, according to this invention, divide the ith main data block into two parts (the ith main data block I and the ith main data block II) as shown in FIG. 4(B). The two parts are respectively stored into the (L₍ᵢ₋₁₎+1)th through the Mth and the first through the (Sᵢ−M+L₍ᵢ₋₁₎)th memory units of the memory 40.

Furthermore, the ith main data block includes both the ith audio data corresponding to the ith audio frame and the (i+1)th audio data corresponding to the (i+1)th audio frame.

As shown in FIG. 4(B), one part of the ith audio data is included in the (i−1)th main data block; the other part of the ith audio data is included in the ith main data block I. When the MP3 decoder requests to access the ith audio data from the memory 40, the methods and apparatuses, according to this invention, can find out the beginning position of the ith audio data based on the ith beginning index (Bᵢ) and the value of L₍ᵢ₋₁₎.

For the ith audio data, the part included in the (i−1)th main data block is still stored in the memory 40 instead of being over-written or deleted. Because the memory 40, according to this invention, is a circular input buffer, the MP3 decoder can sequentially access the ith audio data from the memory 40, after finding out the beginning position of the ith audio data. More specifically, according to this invention, when the part of the ith audio data included in the (i−1)th main data block is requested to be accessed, the (i−1)th main data block doesn't have to be re-loaded into the memory 40 as in prior art. A pointer in the memory 40 is typically used for labeling the end of a previous accessing operation. Theoretically, before the ith audio data is accessed, the pointer is at the end position of the (i−1)th audio data. Therefore, the MP3 decoder can directly start to access the ith audio data from the end position of the (i−1)th audio data. Moreover, another advantage of this invention is that as long as the size of the memory 40 is large enough for storing the longest audio data in the audio stream, it is enough for the requirement. Compared to some prior arts, costs for the memory can be considerably decreased according to this invention.

After the ith main data block is stored, the main data blocks of subsequent audio frames can be sequentially stored into the memory 40. FIG. 4(C) illustrates the memory 40 after the (i+1)th main data block is stored. As shown in FIG. 4(C), if the ith audio data is successfully decoded by the MP3 decoder, the (i+1)th main data block will be able to being over-written into the memory units that previously stored the (i−1)th main data block.

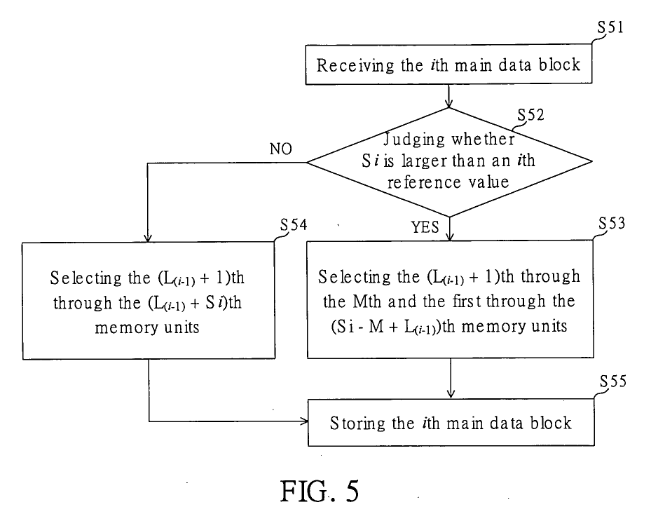

FIG. 5 shows the flowchart of the managing method in the first preferred embodiment according to this invention. In step S51, the ith main data block in the ith audio frame is first received. In step S52, it is judged that whether the value of Sᵢ is larger than an ith reference value. If the judging result of step S52 is YES, step S53 is performed. In step S53, the (L₍ᵢ₋₁₎+1)th through the Mth and the first through the (Sᵢ−M+L₍ᵢ₋₁₎)th memory units among the M memory units are selected as an ith set of memory units for storing the ith main data block. If the judging result of step S52 is NO, step S54 is performed. In step S54, the (L₍ᵢ₋₁₎+1)th through the (L₍ᵢ₋₁₎+Sᵢ)th memory units among the M memory units are selected as the ith set of memory units. In step S55, the ith main data block is stored into the ith set of memory units.

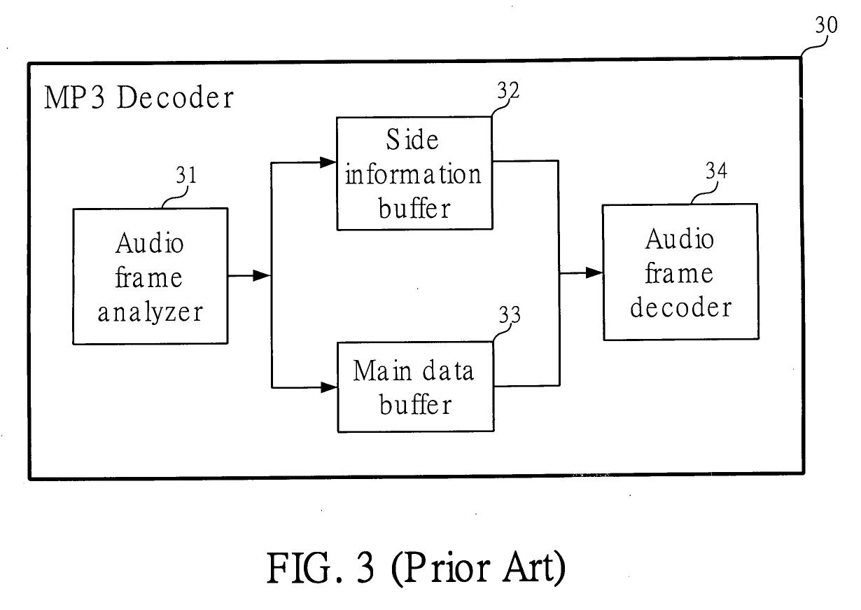

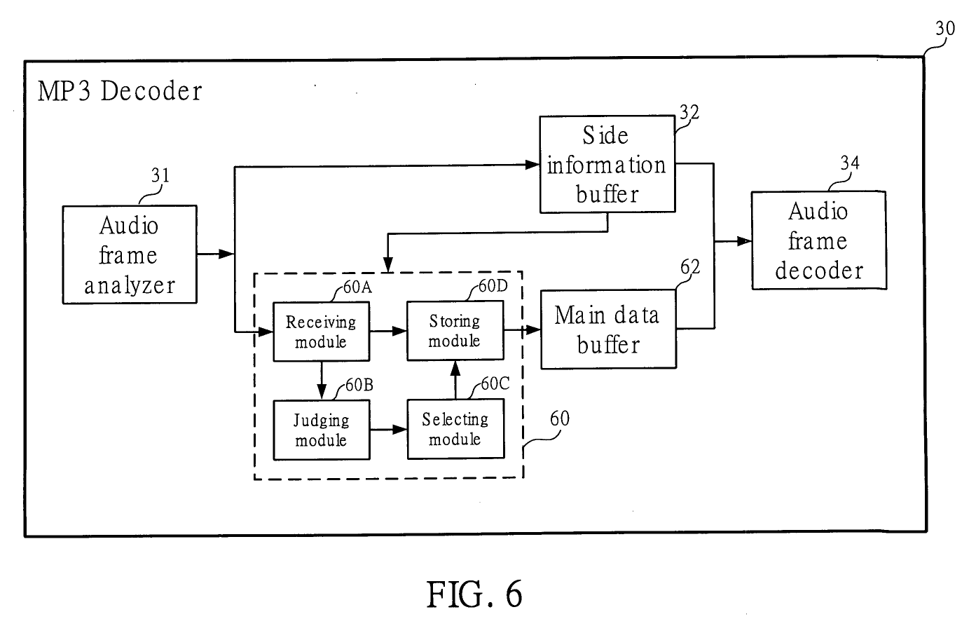

The second preferred embodiment, according to this invention, is a managing apparatus 60 for managing a memory. FIG. 6 shows the block diagram when the managing apparatus 60 is integrated with the MP3 decoder in FIG. 3. According to this invention, the main data buffer 62 in FIG. 6 is a memory that includes M memory units. The managing apparatus 60 includes a receiving module 60A, a judging module 60B, a selecting module 60C, and a storing module 60D. The receiving module 60A is used for receiving the ith main data block in the ith audio frame from the audio frame analyzer 31. The judging module 60B is coupled to the receiving module 60A and used for judging whether the value of Sᵢ is larger than an ith reference value. According to judging result of the judging module 60B and the values of M, Sᵢ, and L₍ᵢ₋₁₎, the selecting module 60C selects an ith set of memory units from the M memory units. Then, the storing module 60D stores the ith main data block into the ith set of memory units. The side information buffer 32 can also be coupled to the managing apparatus 60 and provide the ith beginning index (Bᵢ) in the side information block of the ith audio frame.

In actual application, the managing apparatus 60 can further include a searching module (not shown in this figure). When a user requests to access the ith audio data from the memory, the searching module can be used to find out a beginning position of the ith audio data in the main data buffer 62 based on the ith beginning index (Bᵢ) and the value of L₍ᵢ₋₁₎.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method of managing a memory in an apparatus for decoding an audio bit stream, the audio bit stream comprising N audio frames, the memory comprising M memory units and being used for temporarily storing at least one audio frame in the audio bit stream, N and M being positive integers, the ith audio frame among the N audio frames comprising an ith main data block with a size equal to Sᵢ memory units, i being an integer index ranging from 1 to N, Sᵢ being a positive integer smaller than or equal to M, the last used memory unit for storing the (i−1)th main data block being the (L₍ᵢ₋₁₎)th memory unit in the memory, said method comprising the steps of:
(a) receiving the ith main data block in the ith audio frame;
(b) judging whether the value of Sᵢ is larger than an ith reference value;
(c) according to the judging result of step (b) and the values of M, Sᵢ, and L₍ᵢ₋₁₎, selecting an ith set of memory units from the M memory units; and
(d) storing the ith main data block into the ith set of memory units.

2. The method of claim 1, wherein the ith reference value is equal to the difference between the values of M and L₍ᵢ₋₁₎.

3. The method of claim 2, wherein if the judging result of step (b) is NO, the ith set of memory units comprises the (L₍ᵢ₋₁₎+1)th through the (L₍ᵢ₋₁₎+Sᵢ)th memory units among the M memory units.

4. The method of claim 2, wherein if the judging result of step (b) is YES, the ith set of memory units comprises the (L₍ᵢ₋₁₎+1)th through the Mth and the first through the (Sᵢ−M+L₍ᵢ₋₁₎)th memory units among the M memory units.

5. The method of claim 1, wherein the ith audio frame is corresponding to an ith audio data, and the ith main data block selectively comprises at least one audio data among the ith audio data through the Nth audio data.

6. The method of claim 5, wherein an ith beginning index (Bᵢ) corresponding to the ith audio data is previously provided and represents a relative relationship between the ith audio data and the ith main data block.

7. The method of claim 6, the method further comprising the step of:
(e) when the apparatus requests to access the ith audio data from the memory, finding out a beginning position of the ith audio data in the memory based on the ith beginning index (Bᵢ) and the value of L₍ᵢ₋₁₎.

8. The method of claim 7, wherein the beginning position of the ith audio data is the (L₍ᵢ₋₁₎+Bᵢ)th memory unit in the memory.

9. The method of claim 1, wherein the apparatus is an MP3 decoder.

10. An apparatus of managing a memory in an audio decoder for decoding an audio bit stream, the audio bit stream comprising N audio frames, the memory comprising M memory units and being used for temporarily storing at least one audio frame in the audio bit stream, N and M being positive integers, the ith audio frame among the N audio frames comprising an ith main data block with a size equal to Sᵢ memory units, Sᵢ being a positive integer smaller than or equal to M, i being an integer index ranging from 1 to N, the last used memory unit for storing the (i−1)th main data block being the (L₍ᵢ₋₁₎)th memory unit in the memory, said apparatus comprising:
a receiving module for receiving the ith main data block in the ith audio frame;
a judging module coupled to the receiving module, the judging module being used for judging whether the value of Sᵢ is larger than an ith reference value;
a selecting module for selecting an ith set of memory units from the M memory units according to the judging result of the judging module and the values of M, Sᵢ, and L₍ᵢ₋₁₎; and
a storing module for storing the ith main data block into the ith set of memory units.

11. The apparatus of claim 10, wherein the ith reference value is equal to the difference between the values of M and L₍ᵢ₋₁₎.

12. The apparatus of claim 11, wherein if the judging result of the judging module is NO, the ith set of memory units comprises the (L₍ᵢ₋₁₎+1)th through the (L₍ᵢ₋₁₎+Sᵢ)th memory units among the M memory units.

13. The apparatus of claim 11, wherein if the judging result of the judging module is YES, the ith set of memory units comprises the (L₍ᵢ₋₁₎+1)th through the Mth and the first through the (Sᵢ−M+L₍ᵢ₋₁₎)th memory units among the M memory units.

14. The apparatus of claim 10, wherein the ith audio frame is corresponding to an ith audio data, and the ith main data block selectively comprises at least one audio data among the ith through the Nth audio data.

15. The apparatus of claim 14, wherein an ith beginning index (Bᵢ) corresponding to the ith audio data is previously provided and represents a relative relationship between the ith audio data and the ith main data block.

16. The apparatus of claim 15, the apparatus further comprising:
a searching module, when a user requests to access the ith audio data from the memory, the searching module finding out a beginning position of the ith audio data in the memory based on the ith beginning index (Bᵢ) and the value of L₍ᵢ₋₁₎.

17. The apparatus of claim 16, wherein the beginning position of the ith audio data is the (L₍ᵢ₋₁₎+Bᵢ)th memory unit in the memory.

18. The apparatus of claim 10, wherein the audio decoder is an MP3 decoder.
